(19) United States
(12) Patent Application Publication
(10) Pub. No.: US 2012/0031715 A1
(43) Pub. Date: Feb. 9, 2012

(54) INDUSTRIAL MOTOR BRAKING SYSTEM

(76) Inventor: EDWARD R. CONWAY, Douglassville, PA (US)

(21) Appl. No.: 12/849,512

(22) Filed: Aug. 3, 2010

(51) Int. Cl. F16D 55/225; F16D 55/2265

(52) U.S. Cl. 188/72.3; 188/72.1

(57) ABSTRACT

The present invention provides industrial spring applied caliper braking systems which include a friction disc, a spring applied thruster and a caliper base comprising a friction facing. The caliper base is selectively activated by the spring applied thruster to apply said friction facing to the friction disc, and deactivated upon the application of a minimum pressure to release said friction facing from said friction disc. The braking system further includes a roller guide assembly including a roller guide arm, a high temperature roller wheel disposed on a distal end portion of the roller guide arm. The caliper base and roller guide assembly are mounted to a floating bracket assembly for allowing the caliper base and the roller guide assembly to slide orthogonally to a center line of the friction disc in response to at least thermal expansion driven axial float of said friction disc.

### FIELD OF THE INVENTION

The present invention relates to industrial motor braking systems, and specifically those that include spring applied thrusters, friction discs and calipers.

### BACKGROUND OF THE INVENTION

On virtually every large industrial motor of at least about 250 HP or greater, internal heat generated in the motor causes the main drive shaft to expand outwardly. This is known as “thermal expansion” of the driving shaft. As the motor, such as an electric motor, or diesel engine, cools, the shaft shrinks back down to its original size at ambient temperature. In the industry, this is generally referred to as the “axial float” or “end float”. While most brake pads require a 1 mm clearance (2 mm total), between the friction disc of these motors and the friction facings, in extreme cases of axial float, the axial float of the motor shaft is often greater than 1 mm (0.0393 inches), and can often reach as high as ⅜-½ inches (9.54-12.72 mm).

As with any brake system, caliper, drum or shoe, the air gap tolerance is extremely critical. The air gap tolerance is defined as the distance between the face of the friction surface and the face of the braking surface. In industrial sized motors, the braking surface is typically a friction disc or drum. The brakes are normally open, with at least a 1 mm gap, until an emergency, when someone hits an emergency stop button or if there is a loss of power. This is why spring applied brakes are also called “fail-safe” brakes.

If one assumes a standard air gap tolerance between the pads and the disc of 1 mm or less (0.0393 inches) for industrial spring applied thruster brakes, and the motor has an axial float of ⅜ inches (0.54 mm), which is common, it would be difficult for any brake system that was fix mounted to a rigid structure to provide the necessary tolerance for proper braking. This can be explained by the following example: if a caliper brake requires a minimum 1 mm (0.0393 inch) of air gap tolerance, but the motor shaft has an axial float of ⅜ inches (9.54 mm; 0.375 inches), the resulting “clearance” would be 0.0393 inches−0.375 inches=negative 0.3375 inches. This would cause the friction disc to rub against the friction lining or pads as soon as the shaft expanded and cause premature wear for both friction material and motor bearings, excessive heat and possibly fire.

Accordingly, there is a need for a spring applied thruster caliper brake system that maintains the recommended manufacturer's air gap tolerance. There also remains a need for a caliper braking system that can continually hold the center line positions of the caliper brake and the rotor or friction disc in alignment.

### SUMMARY OF THE INVENTION

The present invention provides an industrial motor braking system comprising a friction disc of at least 14 inches (35.56 cm); a spring applied thruster; a caliper base comprising a friction facing, said caliper base being selectively activated by such spring applied thruster to apply said friction facing to said friction disc to provide a braking force of at least sufficient to brake a 250 HP motor. The system also includes a roller guide assembly including a pair of roller guide arms disposed on opposite sides of the caliper base, and a high temperature roller wheel disposed in direct contact with the friction disc on a distal end location of each roller guide arm. The system further includes a floating bracket comprising a base plate, a slide plate disposed to slide relative to said base plate in response to at least a thermal expansion driven axial float of said friction disc, and guide means for limiting the relative sliding movement between the base plate and the slide plate. In this embodiment, the spring applied thruster, caliper base and roller guide assembly is mounted to the floating bracket.

The present braking system with its floating bracket assembly keeps center line alignment between the friction disc and the caliper brake assembly. This can be achieved by squeezing the brake disc with the provided high temperature roller wheels. This is also assisted by guide means, which may include plunger pins and a guide channel which prevents the brake assembly from twisting or pivoting, but allows it to travel evenly from right to left, and left to right, generally orthogonally to the center line of the friction disc. Further, the floating bracket assembly of this invention can provide a floating relationship between the base plate and the slide plate, so that the slide plate can float pneumatically, hydraulically, or by a low friction bearing surface over the base plate. For example, an air gap can be located on both the right and left sides of the slide plate, to allow lateral movement.

In a further embodiment of the present invention, a spring applied caliper braking system for industrial applications is provided. The system includes a friction disc of at least 14 inches (35.56 cm) in diameter, a spring applied thruster, a caliper base comprising a friction facing, said caliper base being selectively activated by said spring applied thruster to apply said friction facing to said friction disc, and deactivated upon the application of a minimum pressure from said thruster spring to release said friction facing from said friction disc. The system further includes a roller guide assembly, including a roller guide arm and a high temperature roller wheel disposed on a distal end location of said roller guide arm, whereby at least said caliper base and said roller guide assembly are mounted to a floating bracket assembly for allowing said caliper base and roller guide assembly to slide orthogonally to a center line of said friction disc in response to at least thermal expansion driven axial float of said friction disc.

### BRIEF DESCRIPTION OF THE DRAWINGS

The accompanying drawings illustrate preferred embodiments of the invention, as well as other information pertinent to the disclosure, in which:

FIG. 1 is a front perspective of a dual brake motor braking assembly showing two spring applied caliper brakes applied to a friction disc;

FIG. 2 is a front plan view of the dual brake motor braking system of FIG. 1;

FIG. 3 is a top plan view of the right spring applied caliper brake of FIG. 1;

FIG. 4 is a front perspective, exploded view of the right spring applied caliper brake of FIG. 3 showing its pedestal base;

FIG. 5 is a bottom and rear perspective view of the spring applied caliper brake of FIG. 4, illustrating the bottom of the slide plate;

FIG. 6 is a rear plan view of the spring applied caliper brake of FIG. 3; and

FIG. 7 is a front plan view of a dual brake motor braking system having side caliper mounts.

### DETAILED DESCRIPTION

Spring applied caliper braking systems are provided by this invention. They are typically released by air or hydraulic pressure, although electric and electromagnetic applied pressure, or a combination of these forces, can be used to release them. They typically automatically engage if there is a loss of power. Spring applied caliper brakes are ideal for moderate or high speed, high, dynamic or static torque, cyclic applications, such as in drag line buckets for mining operations.

Spring applied caliper disc brakes function in the opposite manner of traditional brakes. Normal brake operation, such as in caliper disc brakes used for automobiles, requires active pressure to brake and pressure removed to release. Spring applied caliper disc brakes, on the other hand, require active minimum pressure to release. Such a pressure is typically about 50-125 psi, and can be created by pneumatic, hydraulic, electromagnetic, electric assisted pressure, or a combination thereof. At the loss of pressure, energy stored in a spring stack within the spring applied thruster, takes over to stop or hold the mass. Such brakes are ideal for emergency stopping or holding of industrial machinery, such as those used in excavation and large scale manufacturing.

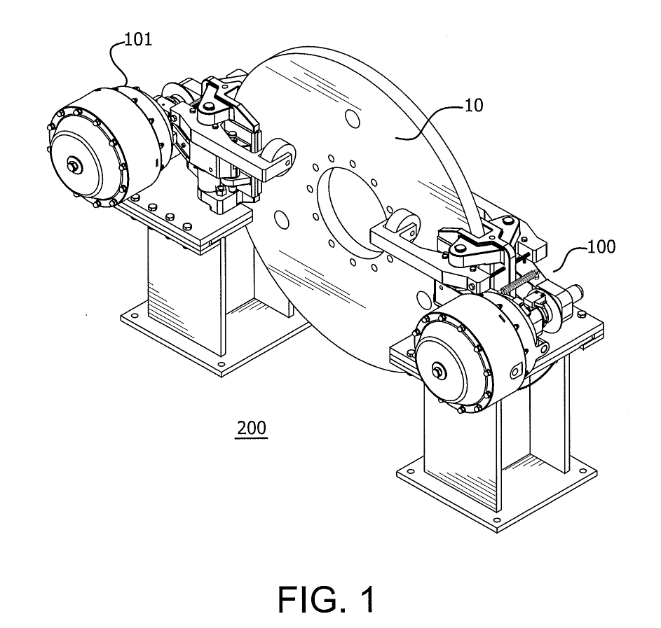

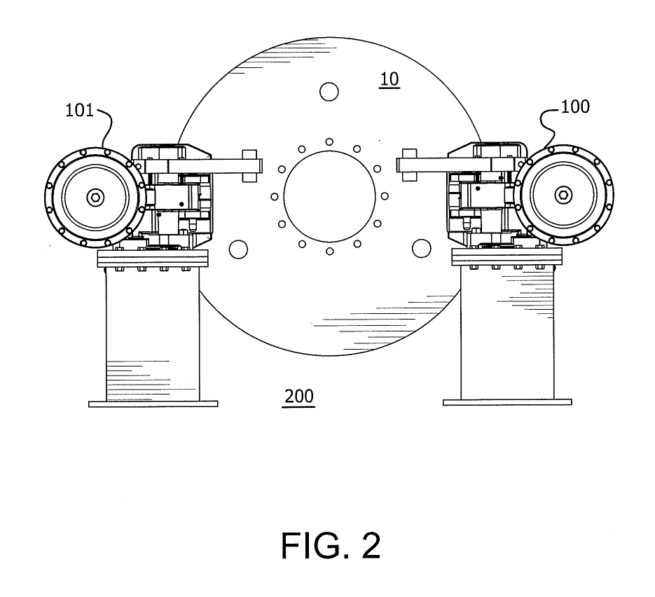

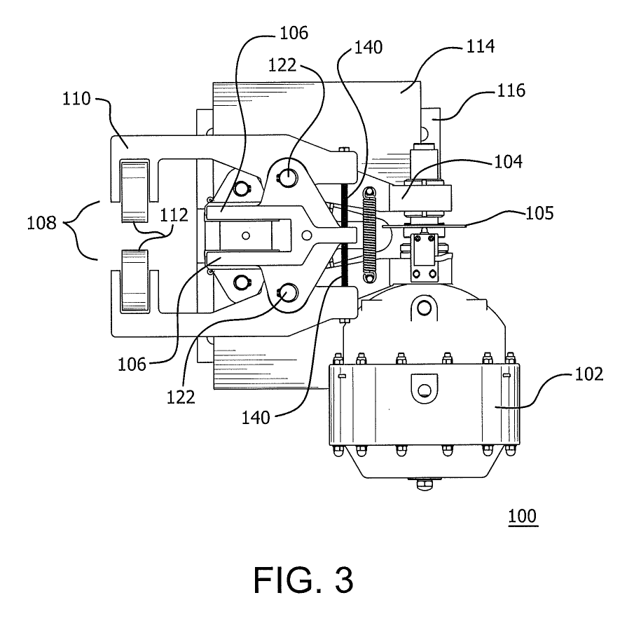

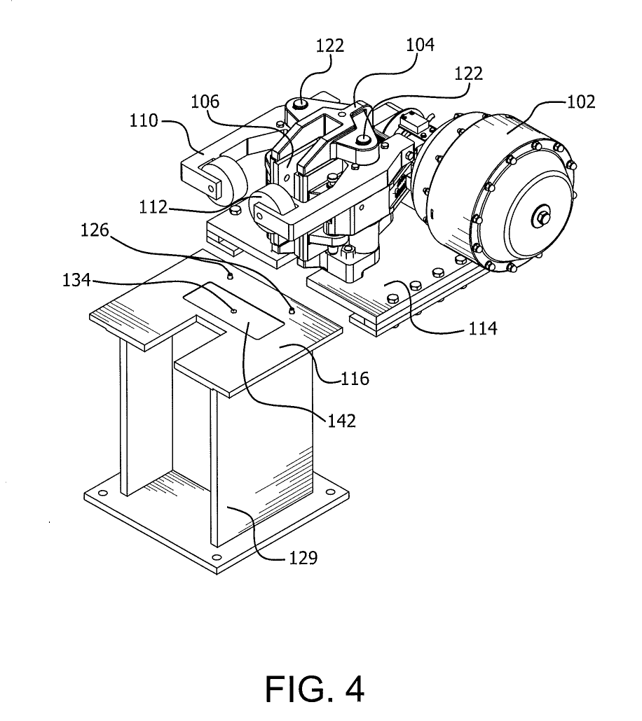

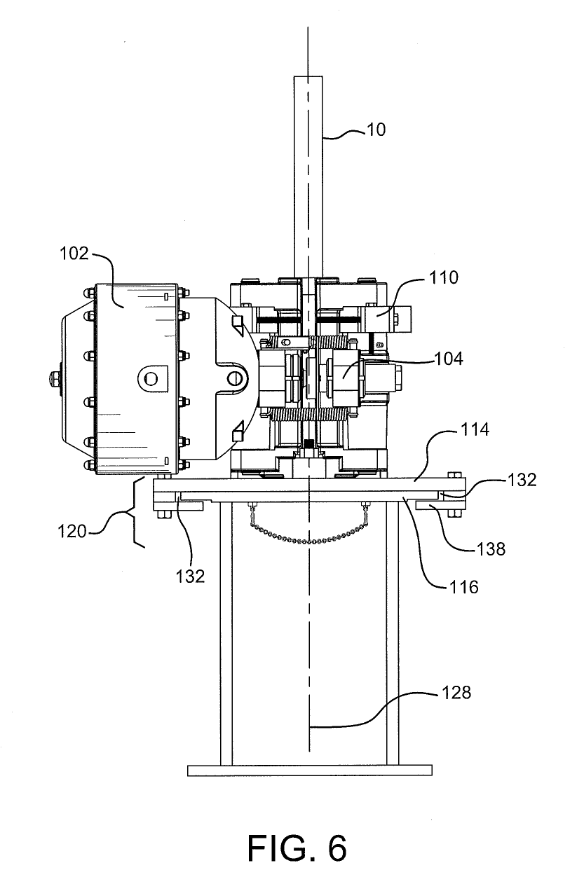

With reference to the figures, and in particular, FIGS. 1-6 thereof, there is shown a dual brake motor braking system 200 having a friction disc 10 and a pair of spring applied caliper brakes 100 and 101. The friction disc is typically made of steel and is also typically at least about 14 inches (35.56 cm) in diameter, and commonly about 25-75 mm in thickness, more commonly about 40 mm in thickness, but can be machined down to about 30 mm in thickness by removing about 5 mm from each side of the friction disc 10. The friction disc 10 includes a center line 128, shown in FIG. 6, which is designed to match the center line 105 of the caliper base 104, shown in FIG. 3. The brake pads or friction facings 106 shown in FIG. 4, are typically “positively engaged” with the friction disc 10, when there is a loss of power, but there is typically about 1 mm clearance for each friction facing or pad 106 during use, prior to engagement of the brake, for a total of 2 mm clearance between the friction facings 106 and the friction disc 10.

During use, the axial float of the drive shaft connected to the friction disc 110 expands commonly by at least about 1 mm (0.0393 inches) and as much as ⅜-½ inches (9.54-12.72 mm), due to thermal expansion, as the shaft heats from ambient temperature to an elevated temperature. This ⅜ inch expansion in combination with the high RPMs of the motor, typically in the area of about 900-1200 RPMs, causes the friction facings 106 to push to one side, burning them up and potentially damaging the disc. By machining 5 mm from each side of the friction disc 10, users typically permit greater axial float, but cause the disc to have less mass, which results in less dissipation of heat or energy from the motor. This, in turn, causes the friction discs 10 to heat up even higher, resulting in disc lift and discoloration. After a single stop, the disc can raise its temperature another 300° F., from about 500° F. to about 800° F., causing further damage to the friction facings 106.

The spring applied caliper brake 100 of this invention is described in FIG. 3. The caliper brake 100 includes a spring applied thruster 102 which can be released by pneumatic, hydraulic, electric or electromagnetic power, for example. The brake 100 further includes a caliper base 104 having a pair of caliper arms, each of which is equipped with friction facings 106 for contacting the friction disc 10. The brake 100 further includes a roller guide assembly 108 including a pair of roller guide arms 110 disposed on opposite sides of the caliper base 104. The roller guide arms 110 can be fastened with the caliper base by a pin fastener 122 passing through aligned holes in the caliper base 104 and each of the roller guide arms 110, shown in FIG. 3. The roller guide assembly further includes a pair of high temperature roller wheels 112 disposed in direct contact with the friction disc 10 on the distal end location of each roller guide arm 110. The brake 100 further includes a base plate 116 (or middle plate) and slide plate 114 disposed to slide relative to the base plate 116 in response to at least a thermal expansion driven axial float of the friction disc 10 and shaft. The slide plate 114 in combination with the base plate 116 is referred to as the floating bracket assembly 120. The brake 100 further includes guide means for limiting the relative sliding movement between the base plate and the slide plate. The spring applied thruster 102, caliper base 104 and roller guide assembly 108 are preferably mounted to the side plate 114, and can slide back and forth over the base plate 116.

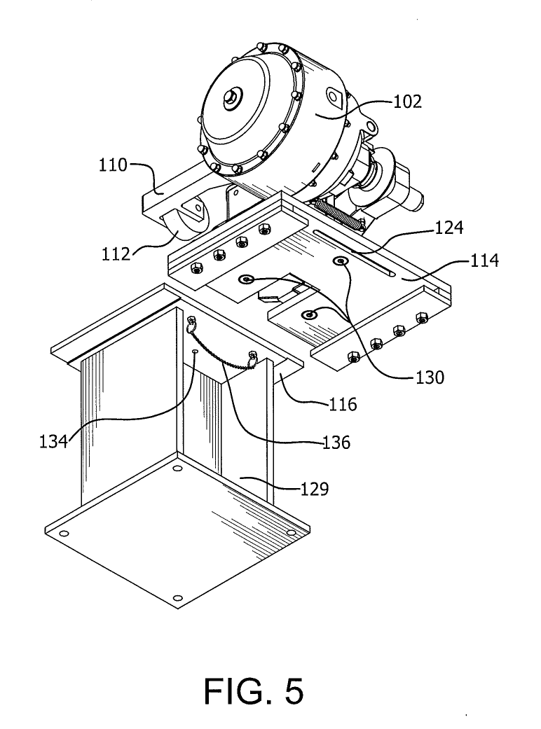

In view of FIG. 4, an air pocket 142 is disposed in the preferred base plate 116 with an air inlet port 134. The base plate also includes pins, such as spring loaded plunger pins 126. The plunger pins 126 align in the guide channel 124, shown in the bottom of the slide plate 114 in FIG. 5. The slide plate 114 with the caliper brake 100 secured thereon, for example, through brake mounting holes 130 and fasteners, is then slid onto the base plate 116 until the spring loaded plunger pins 126 pop into the guide channel 124. Desirably, the guide channel 124 is in the form of a slotted groove, although a pair of slotted grooves or an elongated opening could be similarly employed. When the pins 126 are properly seated in the guide channel 124, the slide plate 114 and caliper brake 100 can only move from side to side. The plunger pins 126 prevent the slide plate 114 and caliper brake 100 from moving from front to rear. If one needs to remove the caliper brake 100 or inspect the friction facings 106, one need only pull down on the release chain 136, shown in FIG. 5, to withdraw the plunger pins 126 from the guide channel 124 so that the slide plate 114 can be removed with its mounted caliper brake 100.

When the slide plate 114 and caliper brake 100 are properly mounted and aligned with the base plate 116, the slide plate 114 and caliper brake 100 can only slide laterally in both right and left directions a maximum distance equal to the sum of the air gaps 132, shown in the rear plan view of FIG. 6, sandwiched between the slide plate 114 and clamping plate 138. Preferably, each air gap 132 is about ½-1″, more preferably about ⅝″ on each side of the disc. The plunger pins 126 prevent the floating bracket assembly 120 from sliding from front to rear during movement within the air gaps 132.

With reference to FIGS. 1-4, the roller guide assembly 108 will now be described. Several commercial caliper braking systems that can be engaged with the floating bracket assembly 120 and roller guide assembly 108 of this invention are described in Table 1.

TABLE 1
Commercial Braking Systems Suitable
for the Floating Bracket System

The Roller Guide Arms were designed to fit the following caliper brakes:
Manufacturer: Coremo Ocmea, Model: E-Series Caliper
Manufacturer: Twiflex Model: GMR-Series Caliper
Manufacturer: Ringspann, Model: DVH 40 FPM and DVH 40 FPM/T
Series Caliper

The roller guide assembly 108 includes one or more roller guide arms 110 and high temperature roller wheel 112 or wheels disposed on a distal end location of the roller guide arm 110 or arms. The high temperature roller wheels are designed to withstand temperatures in excess of 500° F., more preferably in excess of 800° F., and are made of high temperature resistant polymers, such as reinforced phenolic resin. The roller guide arms 110 are typically made of light weight metal, such as aluminum, titanium, or their alloys. The roller guide assembly 108 can be adjusted with roller guide arm adjustment screw 140 so that the calipers can be mounted around the friction disc 10 and the high temperature roller wheel 112 or wheels disposed in contact with the side surface of the friction disc 110. As the motor or engine shaft expands due to heat, the present caliper brake 100 allows the caliper base 104 and roller guide assembly 108 to maintain the manufacturer's air gap tolerance by continually holding the center line positions between the caliper base 104 and the friction disc 10.

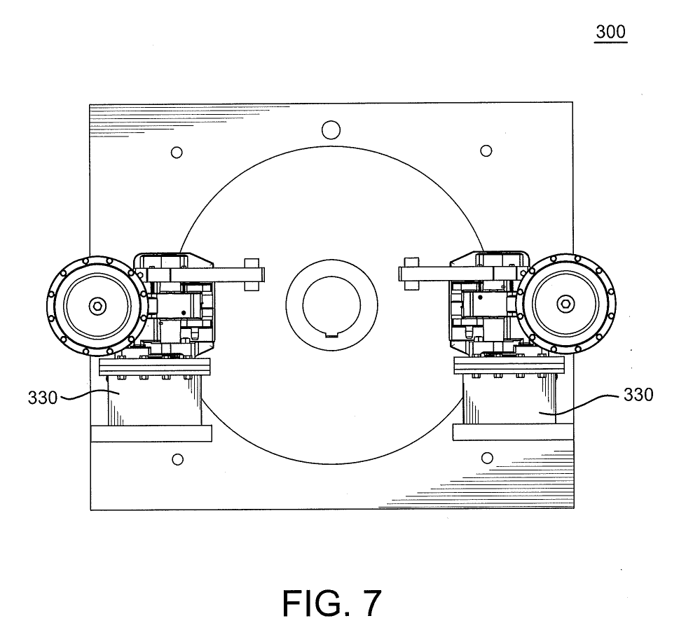

The floating bracket system of this invention can be mounted horizontally, as shown in FIG. 7, or vertically, as shown in FIG. 1. When mounted horizontally the system is referred to as a caliper or side mount, since the caliper brakes 330 are mounted, such as by bolts or welding to the housing of the breaking system 300. When mounted vertically, a pedestal mount 129 or “H” beam can be employed.

Once completely installed, the caliper brake 104 is positioned around the friction disc 10. The roller guide arms 110 are closed until the high temperature roller wheels 112 come in contact with the surface of the brake disc 10. This adjustment is made by turning the roller guide arm adjustment screw 140 until the high temperature roller wheels 112 come in direct contact with the friction disc 10. The user can connect an air source or oil source, for example, to the base plate 116, and with as little as 7 psi pressure in the air gaps 132 and air pocket 142, or a minimum amount of pressure which will allow the slide plate 114 with the mounted caliper brake 104 to move laterally in both the right and left directions over the base plate 116 with as little as 5 lbs of force applied to either component. This design feature helps save the bearing life of the roller guide arms 110 and the bearings of the motor attached to the friction disc 10.

Alternatively, magnetic force, induction coils, super conductors, or hydraulic pressure can be used, or a light coating of grease or oil, Teflon spray or other lubrication, to the surfaces of the slide plate 114, base plate 116, or both. Alternatively, one or both of these surfaces could be coated with a Teflon polymer plate or coating, or ball bearings can be used between the two surfaces to allow them to slide over one another with 5 lbs of force or less. Alternative low friction bearing surfaces such as these can be used by themselves, or in combination.

From the forgoing, it can be realized that this invention provides improved industrial motor braking systems and improved spring applied caliper braking systems for industrial applications. Although various embodiments of the invention have been illustrated, this is for the purpose of describing, but not limiting the invention. Various modifications which will become apparent to one skilled in the art, are within the scope of this invention described in the attached claims.

What is claimed:

1. An industrial motor braking system, comprising:
a) a friction disc of at least about 14 inches (35.56 cm) in diameter;
b) a spring applied thruster;
c) a caliper base comprising a friction facing, said caliper base being selectively activated by said spring applied thruster to apply said friction facing to said friction disc to provide a braking force at least sufficient to brake a 250 HP motor;
d) a roller guide assembly including a pair of roller guide arms disposed on opposite sides of said caliper base and a high temperature roller wheel disposed in direct contact with said friction disc on a distal end location of each roller guide arm; and
e) a floating bracket comprising:
i) a base plate;
ii) a slide plate disposed to slide relative to said base plate in response to at least a thermal expansion driven axial float of said friction disc; and
iii) guide means for limiting the relative sliding movement between said base plate and said slide plate; said spring applied thruster, caliper base and roller guide assembly being mounted to a floating bracket.

2. The braking system of claim 1 wherein said spring applied thruster comprises a release design based upon hydraulic, pneumatic, electromagnetic or electric power applied pressure, or a combination thereof.

3. The braking system of claim 1 wherein said spring applied thruster comprises an active pressure release mechanism.

4. The braking system of claim 1 wherein said caliper base comprises a pair of caliper base arms, each of said arms having at least one aperture thereto for receiving a pin fastener.

5. The braking system of claim 4 wherein each of said pair of roller guide arms comprise an aperture and are mounted to said pair of caliper arms with said pin fasteners.

6. The braking system of claim 1 wherein said base plate and said slide plate are disposed to float over one another pneumatically, hydraulically, magnetically, electromagnetically, by a low friction bearing surface, or a combination thereof.

7. The braking system of claim 6 wherein said floating bracket assembly comprises a guide channel on a first of either said base plate or said slide plate and at least two pins located on the second of said side plate or base plate for limiting the sliding motion of said base plate in relation to said slide plate.

8. The braking system of claim 7 wherein said guide channel comprises a slotted groove in the lower section of said slide plate and said pins are located at least on the top surface of said base plate.

9. The braking system of claim 8 wherein said pins comprise spring loaded plunger pins.

10. The braking system of claim 1 wherein said floating bracket assembly helps to align a center line of the caliper base to a center line of the friction disc during a thermal expansion axial float of said friction disc.

11. The braking system of claim 9 wherein said slide plate can be removed from said base plate by depressing the spring loaded plunger pins and sliding the slide plate away from the friction disc.

12. A spring applied caliper braking system for industrial applications, comprising:
a) a friction disc of at least about 14 inches (35.56 cm) in diameter;
b) a spring applied thruster;
c) a caliper base comprising a friction facing, said caliper base being selectively activated by said spring applied thruster to apply said friction facing to said friction disc and deactivated upon the application of a minimum pressure to release said friction facing from said friction disc;
d) a roller guide assembly including a roller guide arm, and a high temperature roller wheel disposed on a distal end location of said roller guide arm;
wherein at least said caliper base and said roller guide assembly are mounted to a floating bracket assembly for allowing said caliper base and roller guide assembly to slide orthogonally to a center line of said friction disc in response to at least thermal expansion driven axial float of said friction disc.

13. The braking system of claim 12 wherein said floating bracket assembly employs pneumatic power, hydraulic power, magnetic force, electromagnetic force, a low friction bearing surface, or a combination thereof.

14. An industrial electric motor of at least 250 horsepower comprising the spring applied caliper braking system of claim 12.

15. A industrial diesel engine of at least 250 horsepower comprising the spring applied caliper braking system of claim 12.

16. The braking system of claim 12 wherein an axial float caused by thermal expansion is at least about 1 mm.
